(19) United States
(12) Patent Application Publication
(10) Pub. No.: US 2025/0345149 A1
(43) Pub. Date: Nov. 13, 2025

(54) CONTAMINANT SCAVAGING SYSTEM, APPARATUS, AND METHOD

(71) Applicants: James DiMarino, Naples, FL (US); Richard Rosenthal, Philadelphia, PA (US)

(72) Inventors: James DiMarino, Naples, FL (US); Richard Rosenthal, Philadelphia, PA (US)

(21) Appl. No.: 19/275,304

(22) Filed: Jul. 21, 2025

Related U.S. Application Data
(63) Continuation-in-part of application No. 17/319,046, filed on May 12, 2021, now abandoned.
(60) Provisional application No. 63/101,770, filed on May 13, 2020.

(51) Int. Cl. A61C 5/90

(52) U.S. Cl. CPC A61C 5/90

(57) ABSTRACT

The present invention allows dental professionals to more efficiently and effectively control contaminants not only at the source of their creation (the mouth, for example), with optional configurations that comprise tiered guarding layers to protect the patient, the dentist, the dental assistant, the dental hygienist, as well as other dental professionals/staff, other patients, and subsequent patients to be treated in that operatory.

### CROSS-REFERENCE TO RELATED APPLICATIONS

The present application claims the benefit of priority to U.S. Provisional Patent Application No. 63/101,770, filed on May 13, 2020 and entitled “CONTAMINANT SCAVAGING SYSTEM, APPARATUS, AND METHOD.” The present application claims the benefit of priority to U.S. patent application Ser. No. 17/319,046, filed on May 12, 2021 and entitled “CONTAMINANT SCAVAGING SYSTEM, APPARATUS, AND METHOD.” All of these disclosures are hereby incorporated by reference in their entireties.

### BACKGROUND

There are several fields in which the embodiment of invention can be utilized. In the field of dentistry, for example, most of the dental procedures produce an aerosol which can contain pathogens, blood, saliva, tooth/bone fragments which can contaminate the air in a dental operatory for hours, if not contained at the source. The present invention allows dental professionals to more efficiently and effectively control contaminants not only at the source of their creation (e.g., the mouth) but also in a layered manner thereafter in order to create a tiered system of protection from the contaminants for both the patient, the dentist, the dental assistant, the dental hygienist, as well as other dental professionals, other patients, and subsequent patients to be treated in that operatory. Furthermore, a risk exists that contaminants can spread throughout the office through the ventilation system.

Using dentistry as an example, the current state of the art for dental hygienists includes them treating their patients by themselves (i.e., without a dental assistant to assist in providing additional suction and retraction). Dental Professionals create contaminants when performing almost all their normal functions in the dental office. Dental hygienists often use prophy angles to polish teeth which rotates inside the mouth as well as ultrasonic and piezo scalers which vibrate inside the mouth all of which produce aerosols and contaminants. The dentist often must use a high or low speed drill with a rotating bur or diamond of some sort which places contaminants in the air. Dental assistants can create contaminants during routine tasks such as handling instruments, taking impressions, and assisting with suction, performing other dental assisting duties, all of which can spread saliva, blood, or aerosols. Cross-contamination also occurs when surfaces, charts, or equipment are touched with contaminated gloves, emphasizing the need for strict infection control. These contaminants created by dental professionals enter the air and dental operatory putting both the patient, the dental professionals in the office, and subsequent patients at risk of exposure with said contaminants.

One way in which dental professionals try to increase visibility and patient comfort is to have an assistant using suction when the dentist performs their work Which may help reduce some of the contaminants but not all of them. Unfortunately, since dental hygienist often work alone, they do not have someone there to help them with suction, so the contaminants easily escape the mouth. As soon as these contaminants escape the patient's mouth, they are free to spread and live in the air and on the surfaces of the room which creates a threat to both the dental professionals and patients in the office. Some contaminants are more contagious than others, some live longer in the air and on the surfaces than others, but all of which must be cleared from the room before the next patient enters and the dental professional changes their personal protective equipment so as not to contaminate themselves or others. The act of cleaning a room after it has been exposed to contaminants in such a manner is an arduous, tedious, ineffective and time-consuming process which can allow contaminants to remain and infect dental professionals and or subsequent patients. There is no present or predictable way to effectively sterilize the air once the contaminants have exited the mouth. Although the COVID pandemic of 2020 was unprecedented, future such events that may occur require new vigilance, especially in the context of dental care delivery-a device such as this will be the standard of care.

It is with respect to these and other considerations that the various aspects and embodiments of the present disclosure are presented.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

In an embodiment, a comprehensive tiered containment system for minimizing risk of and controlling airborne and biological contaminants from a patient's biological sources, comprises: a first tier comprising continuous suction configured to capture and isolate contaminants directly from a patient; a second tier configured to dynamically provide a multi-directional air curtain to direct and prevent lateral movement of at least one of: airborne contaminants, biological aerosols, particulate matter, and infectious droplets; and a third tier configured to utilize a synergistic decontamination process comprising at least two complementary methods selected from: chemical mist, ultra-violet light, photocatalytic oxidation, targeted electromagnetic radiation, and molecular neutralization techniques.

In an embodiment, a tiered containment system for comprehensive infectious risk management, comprises: a multi-modal tier containment guard dynamically integrating at least one guard applications selected from suction, forced air stratification, chemical neutralization, photodynamic treatment, molecular misting, oxidative processes, and electromagnetic decontamination; and an intelligent control mechanism comprising real-time adaptive algorithms for precisely modulating at least one of: application timing, intensity variations, cross-application synchronization, and pathogen-specific decontamination protocols.

This summary is provided to introduce a selection of concepts in a simplified form that are further described below in the detailed description. This summary is not intended to identify key features or essential features of the claimed subject matter, nor is it intended to be used to limit the scope of the claimed subject matter.

### BRIEF DESCRIPTION OF THE DRAWINGS

The foregoing summary, as well as the following detailed description of illustrative embodiments, is better understood when read in conjunction with the appended drawings. For the purpose of illustrating the embodiments, there is shown in the drawings example constructions of the embodiments; however, the embodiments are not limited to the specific methods and instrumentalities disclosed. In the drawings:

FIG. 1 shows a side view of an example contaminant scavaging apparatus with multiple tiers of containment sources, deployed on a person;

FIG. 2 shows a front view of the example of FIG. 1;

FIG. 3 shows a side view of an example contaminant scavaging apparatus with multiple tiers of containment sources, deployed with a nasal guard on a person;

FIG. 4 shows a front view of the example of FIG. 3;

FIG. 5 shows a side view of another example contaminant scavaging apparatus with multiple tiers of containment sources, deployed on a person;

FIG. 6 shows a front view of the example of FIG. 5;

FIG. 7 shows a further embodiment as an intraoral device;

FIGS. 8A and 8B show examples of embodiments for the field of dentistry including guards that attach to dental devices;

FIG. 9 shows a front view of an example contaminant scavaging apparatus placed in the mouth and expanded to cover entire surface of the lips of a person;

FIG. 10 shows a side view of the example of FIG. 9;

FIG. 11 shows a further embodiment as a guard incorporated into a dental chair headrest;

FIG. 12 shows another embodiment showing a perspective view of a light, a chemical, or a laser which would be directed at a patient's mouth; and

FIG. 13 shows a further embodiment of a device attached to a dental professional.

### DETAILED DESCRIPTION

This description provides examples not intended to limit the scope of the appended claims. The figures generally indicate the features of the examples, where it is understood and appreciated that like reference numerals are used to refer to like elements. Reference in the specification to “one embodiment” or “an embodiment” or “an example embodiment” means that a particular feature, structure, or characteristic described is included in at least one embodiment described herein and does not imply that the feature, structure, or characteristic is present in all embodiments described herein.

Embodiments of this invention provide a system, apparatus, and method for reducing, eliminating, neutralizing, deagglomerating, absorbing, suctioning, vacuuming, knocking down, mitigating, etc. and/or inactivating/lysing/killing/reducing the amount/concentration (herein also referred to as “control” or “controlling”) of but not limited to smoke, restorations (amalgam/composite/etc.), mercury/chemical vapor, aerosols, droplets, airborne particles, vapors, pathogens, viruses, bacteria, fumes, chemicals, exhaust, splatter, sewage, and body fluids (blood, saliva, bone, teeth, urine, feces, etc.) (herein also referred to as “contaminant”) to which operators, patients, providers, workers, etc. are exposed during but not limited to medical, dental, veterinary, automotive, plumbing, residential, professional, commercial, industrial, etc, procedures, techniques, services, etc.

Embodiments of the invention include a shield, armor, protection, border, or some other configuration (herein also referred to as “guard”) that is capable of accommodating multiple variations and goals of protecting individuals. Embodiments of the invention can be made to accommodate applications of various sizes, configurations, and dimensions.

Embodiments of this invention in the field of dentistry for example, are designed to control contaminants in the intra-oral/nasal, and/or peri-oral/nasal, and/or extra-oral/nasal zones (herein also referred to as “contaminant zones” or “CZ”) thereby controlling the progression of contaminants from both the oral and nasal airways past the peri-oral/peri-nasal area and infecting surfaces, airways, and/or individuals.

Embodiments of this invention utilize tiers to control the contaminants in a short amount of time, distance, etc. by layering sources to control the contaminants as swiftly as possible (herein also referred to as “Tier Containment” or “TC”). The TC may include tiers of sources that help to contain contaminants such as but not limited to suction, air, chemicals, light, mists, ozone, lasers, etc. (herein also referred to as “Tier Decontaminant Method” or “TDM”) by pulling, pushing, inactivating, etc. contaminants.

Embodiments of this invention for example may contain a first tier of suction to pull contaminants out of the air, a second tier that creates an air curtain, and a third tier that decontaminates the air. The suction will first attempt to pull a large portion of contaminants out of the air. The air curtain then provides direction to air movement which creates a barrier which can protect against the movement of contaminants from the intra-oral and intra-nasal cavities into the extra-oral environment further reducing the number of contaminants. The third TDM may be a chemical mist or a UV light that can efficiently treat the vastly reduced number of contaminants that got past the first two tiers to disinfect the air in a shorter amount of time and distance. UV light includes but is not limited to UV-C, and UV-far; or laser or other light source, including mounting in or around or on or within any form of clothing or accessories including but not limited to mask frame, eyeglasses, sunglasses, hat, visor, headband, wallet, handbag, cell phone case, wristband or bracelet, necklace or neckwear, keychain, and/or virtual face mask, etc. The combination of these three TDM thereby reduces the contaminants in the extra-oral/nasal air which reduces the need for additional atmospheric decontamination measures.

To adapt embodiments of the invention for multiple purposes, and to standardize the process, embodiments of the invention include adapters that allow for guards and TDMs to be placed under/on top of/into/onto/around, suspended, and/or sealed around an individual to protect them from contaminants. Embodiments eliminate the need for or reduces the expense for large, expensive guards which tend to be at a greater distance from the source of the contaminant. In these embodiments, guards are layered starting at the source of the contaminant and extending away from the source in order to provide an economic, tiered system of protection to best protect individuals from the contaminant. The present invention thus allows crafters, craftsmen, handyman, commercial/industrial workers, mechanics, hobbyists, dental/medical/veterinary and other professionals, etc. to perform actions safety which would otherwise place the individual in the presence of contaminants that could be harmful to them or those around them.

Objects of the invention that pertains to the field of dentistry, for example, include embodiments designed to control contaminants: (1) as close to the source and/or point of aerosol generation as possible; (2) in a tiered approach by using multiple guards at various distances from the source, for example, a Tiered Containment System 1 (TCS1), a Tiered Containment System 2 (TCS2), and a Tiered Containment System 3 (TCS3); (3) by using a variety or adjustable amount of air evacuation or other type of evacuation; (4) by utilizing a variety or adjustable amount of air, light, chemicals, or other medium that directs the contaminants into or away from a guard; (5) by employing the use of light such as but not limited to ultraviolet or laser; and/or (6) by employing the use of a chemical such as but not limited to ozone, an oxidant, etc.

Variations on the above may include higher speeds of applications, higher speeds with screens (e.g., for fine aerosol and not getting clogged with debris), incorporation of a vacuum line running internally or integrated externally and attaching to a suction line at the unit (via a T-valve connection to the high speed suction line). These combinations may then supplement the use of the regular suction tip being used for more non aerosol things like pieces of tooth etc. or replace it like when using an ultrasonic scaler (for example) with no assistant.

A comprehensive multi-tier (e.g., three-tier) system may be implemented to provide an integrated approach combining suction, air curtain, and decontamination of a contamination source such as the entire oral/nasal cavity of a patient. As described further herein, implementations use a “tier containment guard” concept that combines multiple guard applications and/or techniques. A comprehensive approach provides both directing and deactivating/destroying contaminants (e.g., a simultaneous direction and deactivation of contaminants). Predetermined control measures may be used for timing and intensity of applications.

A first tier provides suction. A second tier provides an air curtain with specific air movement direction (which may be controlled by a user, such as a dentist) and a barrier formation against contaminant spread. A third tier provide decontamination using a particular decontamination methodology, with multiple decontamination options (e.g., chemical mist, UV, laser). The system may be continuously operational during a dental or other medical procedure, which helps to provide post-COVID infectious risk management context for example.

In an implementation, a comprehensive tiered containment system for minimizing risk of and controlling airborne and biological contaminants from a patient's biological sources is provided. A first tier of continuous suction is specifically designed to capture and isolate contaminants directly from: patient's oral and nasal cavities, blood aerosols and droplets, saliva-generated particulates, tooth structures and associated biological materials, gingival and periodontal tissue exudates, pulpal tissue and endodontic biological fluids, and surgical and procedural biological waste products.

The first tier suction is configured to: create a localized negative pressure environment, prevent lateral dispersion of biological contaminants, provide immediate containment of potential infectious materials, and minimize cross-contamination risks during medical and dental procedures.

A second tier dynamically creates a multi-directional air curtain to strategically direct and prevent lateral movement of: airborne contaminants, biological aerosols, particulate matter, and infectious droplets.

A third tier utilizes a synergistic decontamination process comprising at least two complementary methods selected from: chemical mist, ultra-violet light, photocatalytic oxidation, targeted electromagnetic radiation, and molecular neutralization techniques.

The decontamination process is configured to: neutralize viral, bacterial, and particulate contaminants, inactivate infectious agents, break down molecular structures of pathogens, and prevent potential transmission of infectious materials.

Aspects include: comprehensive biological source identification, targeted containment strategy, explicit recognition of multiple biological contamination pathways, proactive infection control mechanism, and expanded decontamination strategies.

In an implementation, a tiered containment system for comprehensive infectious risk management comprises: a multi-modal tier containment guard dynamically integrating at least one guard applications selected from suction, forced air stratification, chemical neutralization, photodynamic treatment, molecular misting, oxidative processes, and electromagnetic decontamination, wherein the guard applications are simultaneously and sequentially configured to: capture contaminants at their source, prevent lateral contamination spread, and actively deactivate and destroy pathogenic agents. The system may further comprise an intelligent control mechanism with real-time adaptive algorithms for precisely modulating: application timing, intensity variations, cross-application synchronization, and pathogen-specific decontamination protocols.

Aspects include: specificity of respiratory source, a dynamic multi-modal approach, intelligent control mechanisms, comprehensive pathogen management, and expanded decontamination strategies.

The systems, apparatuses, and techniques provided herein expand protection to the entire oral and nasal cavity. Bacterial and viral loads from a patient's respiratory system are proactively captured and disinfected. In this manner, comprehensive contamination control is provided beyond single-tooth intervention.

Aspects of the systems, apparatuses, and techniques provided herein simultaneously protect a patient and a medical staff from infectious risks by using multiple decontamination (protection) tiers (suction, air curtain, chemical/UV disinfection), by operating continuously throughout a dental procedure while addressing the entire patient respiratory ecosystem as a potential contamination source.

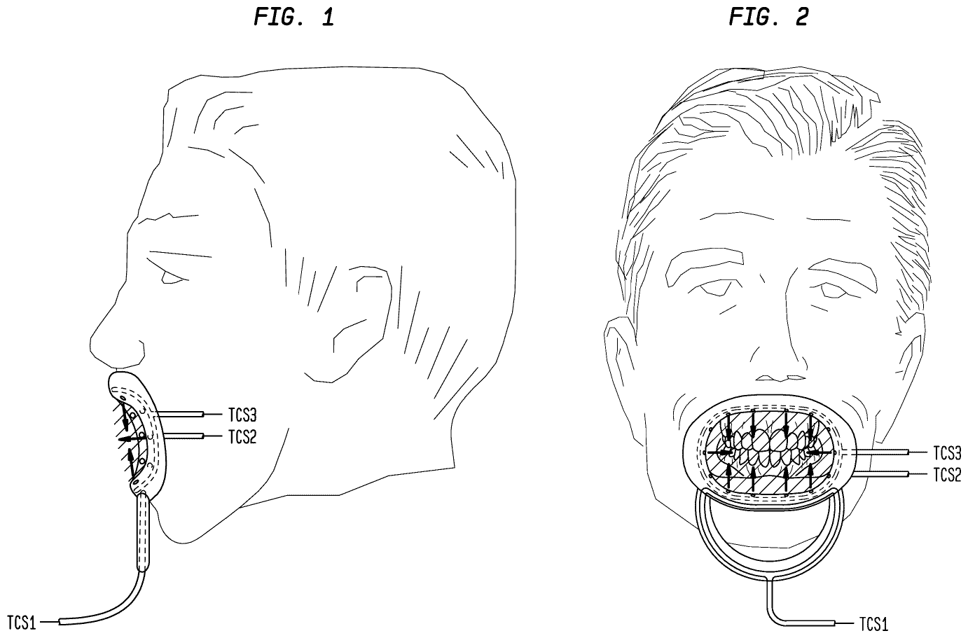

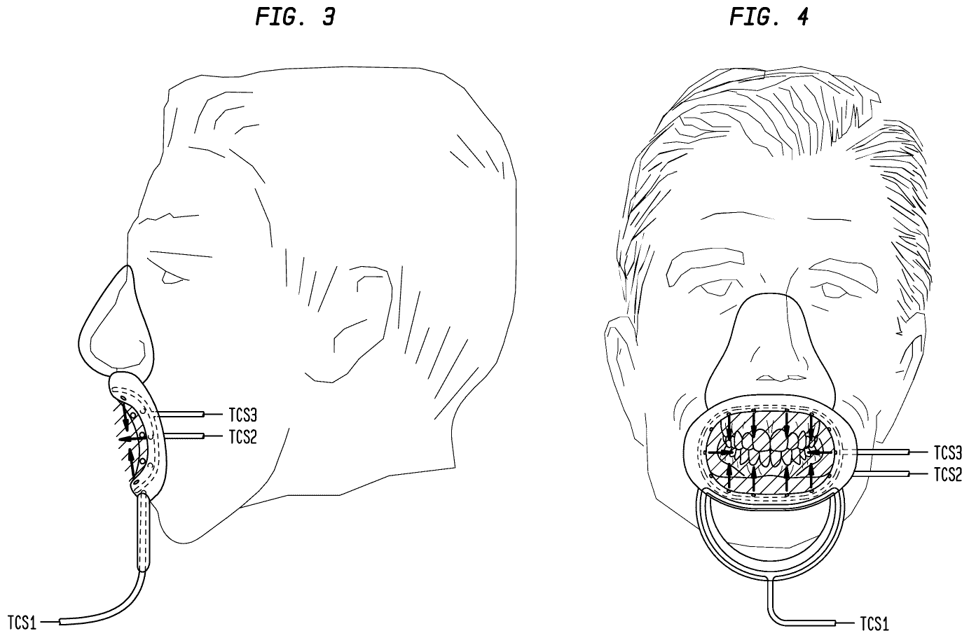

FIG. 1 shows a side view of an example contaminant scavaging apparatus with multiple tiers of containment sources, deployed on a person. FIG. 2 shows a front view of the example of FIG. 1. A guard on cheek retractor is provided, and the apparatus may be considered to be a circumoral device. In an implementation, the cheek retractor may have a built in suction forming ring (not just sides) of suction around the mouth. The bottom part may be hollow and connects to a suction hose and may be disposable because lumen cannot effectively be cleaned. The top part of the apparatus is thicker and sticks up and blocks flow of nasal air and virus and can have suction openings facing a nose to pull in or block exhaled from the nose from entering field. Three tiered containment systems TCS1, TCS2, TCS3 are shown as part of the contaminant scavaging apparatus.

FIG. 3 shows a side view of an example contaminant scavaging apparatus with multiple tiers of containment sources, similar to the example described with respect to FIGS. 1 and 2, and here deployed with a nasal guard on a person. FIG. 4 shows a front view of the example of FIG. 3. In an implementation, a first tier is suction, a second tier is air curtain, and a third tier is decontamination (UV), although this order and arrangement is not intended to be limiting as any number, order, combination, and arrangement of the tiers is contemplated. A source of light, chemical, spray, etc. may be used as a decontaminant to control contaminants. The air curtain source may be used to control contaminants. The suction is a vacuum suction pulling contaminants away from the oral and nasal source.

In an implementation, the cheek retractor becomes the actual suction device. Extension comes up in front of nostrils allowing for breathing but has suction holes facing nostrils to suck in and block exhaled air containing pathogens and acts as a physical barrier to reaching field and also has suction holes like the rest of the device encircling mouth and connection to suction. Opaque plastic may be used so trapped debris is not seen. A filter may be implemented to trap larger particles so as to not clog the suction tube. The filter may be disposable. The apparatus may be injection molded as two halves that are then joined together.

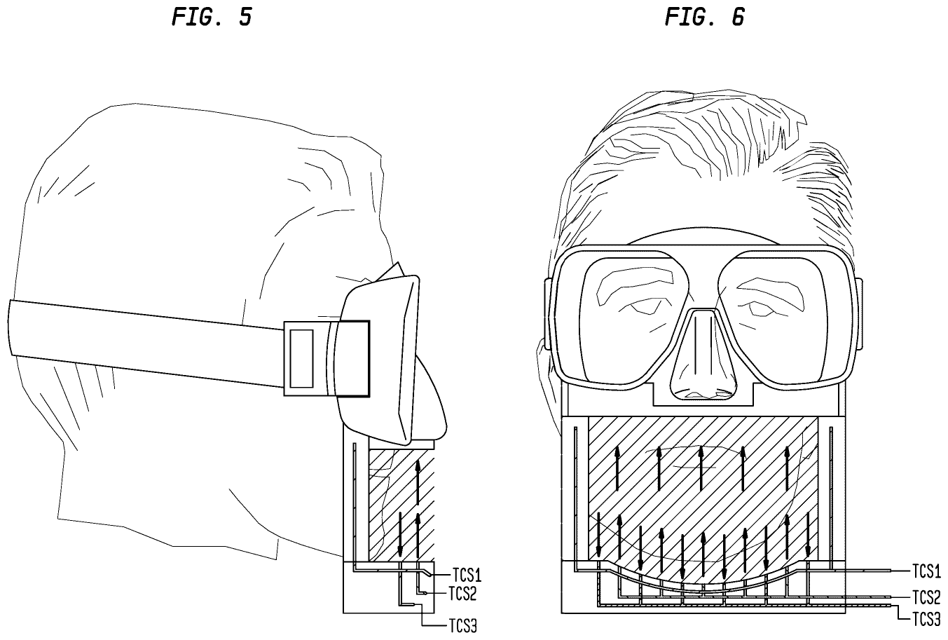

FIG. 5 shows a side view of another example contaminant scavaging apparatus with multiple tiers of containment sources, deployed on a person. FIG. 6 shows a front view of the example of FIG. 5. In an implementation, eye coverings are provided which can attach to a patient bib or other device to complete a seal around the mouth.

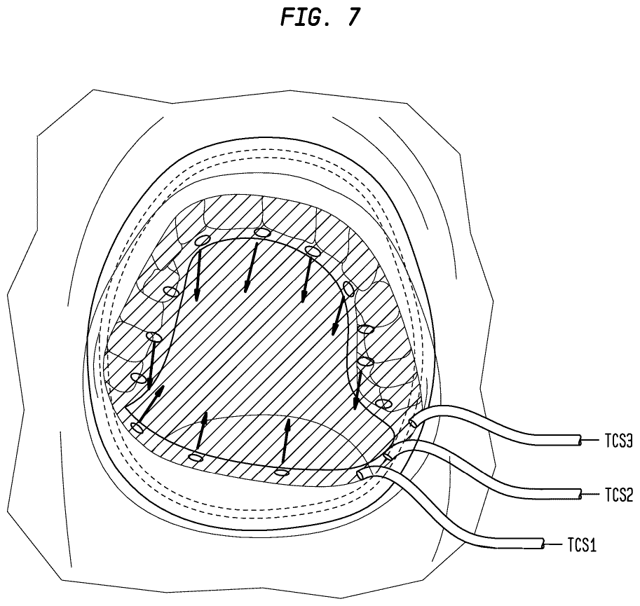

FIG. 7 shows a further embodiment as an intraoral device.

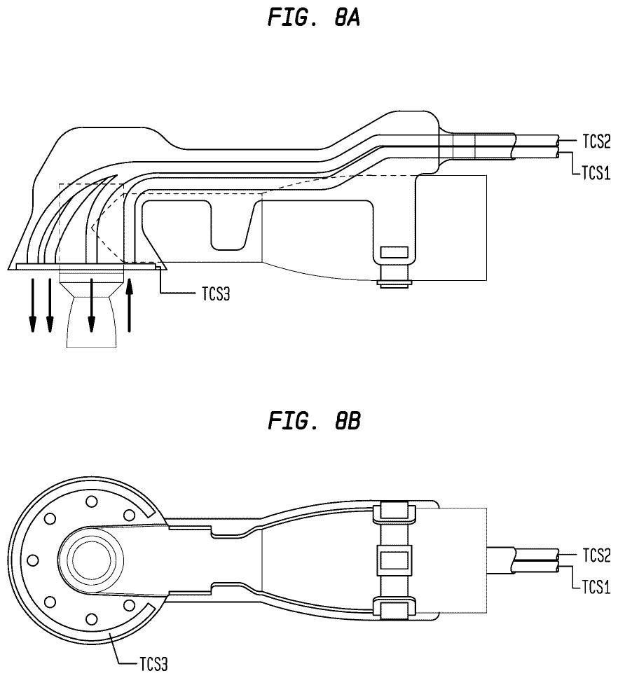

FIGS. 8A and 8B show examples of embodiments for the field of dentistry including guards that attach to dental devices. An example guard can be clipped onto a handle to avoid interfering with grip or slipped over and become part of the grip. In an implementation, a guard can be slipped over the tip and onto the handle so the opening is funnel shaped around the tip and then the rings go completely around the handle. The guard may comprise silicone.

Variations include being attached to high speed permanently, with a screened notch (for fine aerosol and not getting clogged with debris) in the front. It may be a five hole with one vacuum line running internally or integrated externally and attaching to a suction line at the unit (e.g., via a T-valve connection to the high-speed line). This supplements the regular suction tip being used for more non-aerosol things such as pieces of a tooth, etc. or replaces it such as when using a cavitron with no assistant.

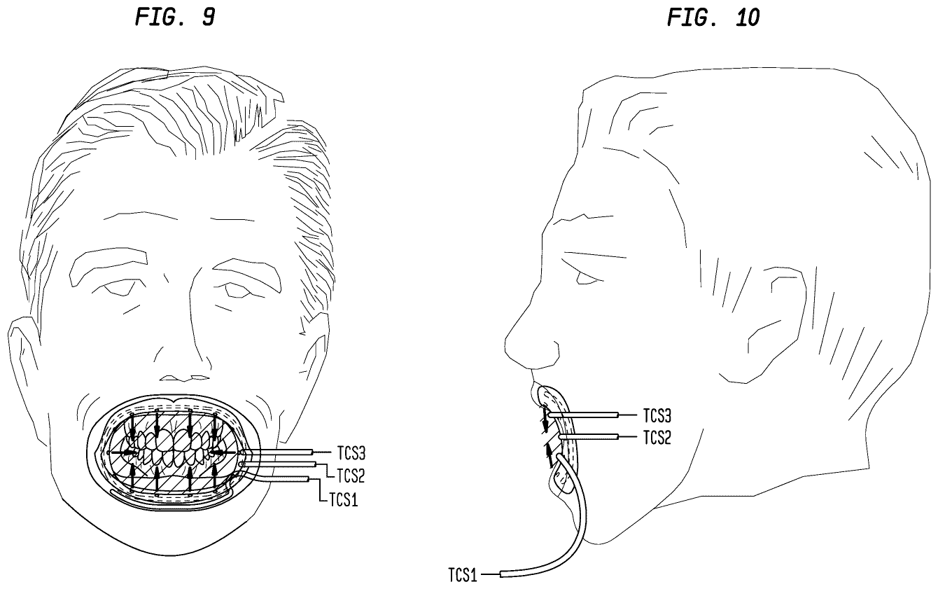

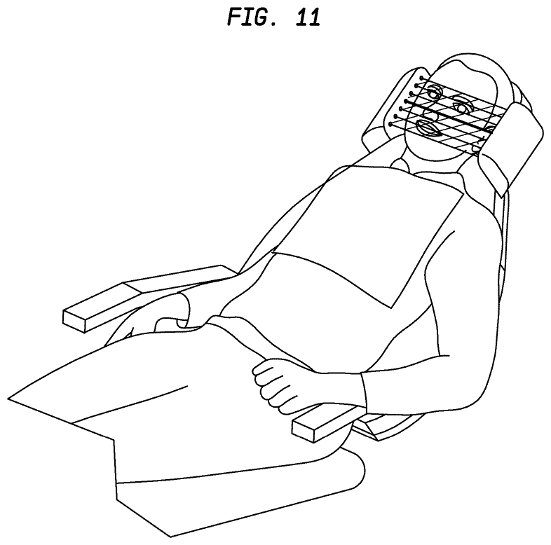

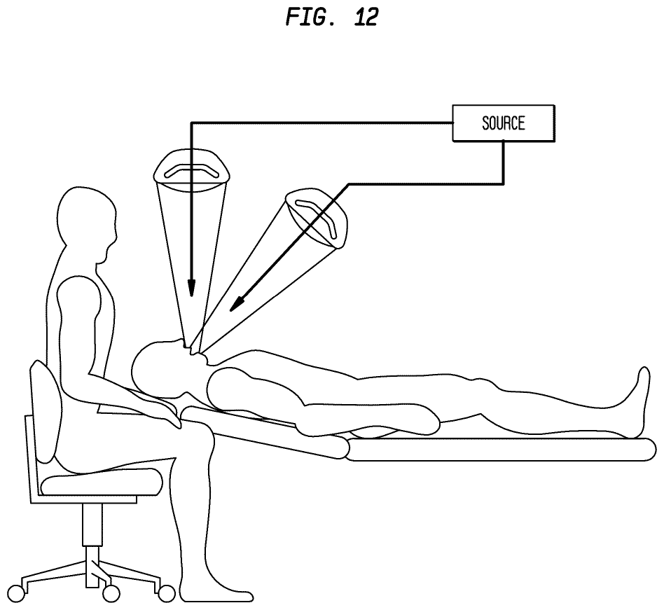

FIG. 9 shows a front view of an example contaminant scavaging apparatus placed in the mouth and expanded to cover entire surface of the lips of a person. FIG. 10 shows a side view of the example of FIG. 9.

FIG. 11 shows a further embodiment as a guard incorporated into a dental chair headrest.

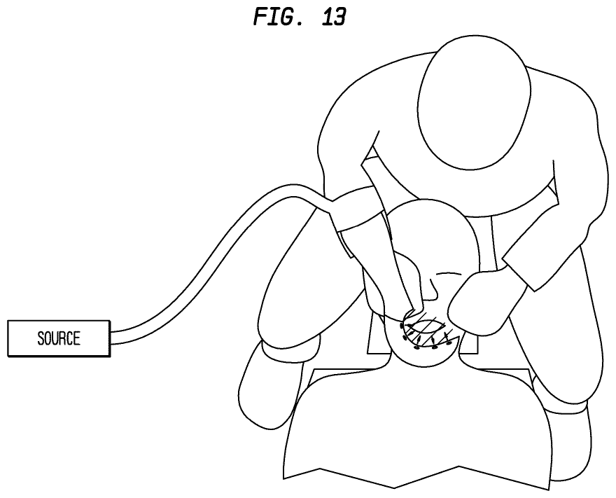

FIG. 12 shows another embodiment showing a perspective view of a light, a chemical, or a laser which would be directed at a patient's mouth.

FIG. 13 shows a further embodiment of a device attached to a dental professional.

In an implementation, a contaminant mitigation system comprises one or more tiers, wherein each tier of the one or more tiers comprises at least one of: suction-based evacuation, air curtain formation, chemical mist dispersion, ultraviolet light sterilization, photocatalytic oxidation, targeted electromagnetic radiation, or molecular neutralization. The number of tiers is configurable (e.g., one tier, two tiers, three tiers, etc., depending on the implementation). The order and/or combination of the tiers is configurable (e.g., a suction tier, an air curtain tier, a tier comprising chemical mist, ultra-violet light, photocatalytic oxidation, targeted electromagnetic radiation, or molecular neutralization techniques, etc.) such that the tiers can be disposed in any order and/or in any combination depending on the implementation.

Although some implementations described herein comprise three tiers (e.g., a suction tier, an air curtain tier, a tier comprising chemical mist, ultra-violet light, photocatalytic oxidation, targeted electromagnetic radiation, or molecular neutralization techniques, etc.), this disclosure is not limited thereto as it is contemplated that any number, order, and/or combination of tiers may be used and/or disposed, depending on the implementation.

As used herein, the singular form “a,” “an,” and “the” include plural references unless the context clearly dictates otherwise. As used herein, the terms “can,” “may,” “optionally,” “can optionally,” and “may optionally” are used interchangeably and are meant to include cases in which the condition occurs as well as cases in which the condition does not occur.

Ranges can be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A comprehensive tiered containment system for minimizing risk of and controlling airborne and biological contaminants from a patient's biological sources, comprising:
a first tier comprising continuous suction configured to capture and isolate contaminants directly from a patient;
a second tier configured to dynamically provide a multi-directional air curtain to direct and prevent lateral movement of at least one of: airborne contaminants, biological aerosols, particulate matter, and infectious droplets; and
a third tier configured to utilize a synergistic decontamination process comprising at least two complementary methods selected from: chemical mist, ultra-violet light, photocatalytic oxidation, targeted electromagnetic radiation, and molecular neutralization techniques.

2. The system of claim 1, wherein the first tier is configured to capture and isolate contaminants directly from at least one of: the patient's oral and nasal cavities, blood aerosols and droplets, saliva-generated particulates, tooth structures and associated biological materials, gingival and periodontal tissue exudates, pulpal tissue and endodontic biological fluids, and surgical and procedural biological waste products.

3. The system of claim 1, wherein the suction if the first tier is configured to: create a localized negative pressure environment, prevent lateral dispersion of biological contaminants, provide immediate containment of potential infectious materials, and minimize cross-contamination risks during medical and dental procedures.

4. The system of claim 1, wherein the decontamination process of the third tier is configured to at least one of: neutralize viral, bacterial, and particulate contaminants, inactivate infectious agents, break down molecular structures of pathogens, and prevent potential transmission of infectious materials.

5. A tiered containment system for comprehensive infectious risk management, comprising:
a multi-modal tier containment guard dynamically integrating at least one guard applications selected from suction, forced air stratification, chemical neutralization, photodynamic treatment, molecular misting, oxidative processes, and electromagnetic decontamination; and
an intelligent control mechanism comprising real-time adaptive algorithms for precisely modulating at least one of: application timing, intensity variations, cross-application synchronization, and pathogen-specific decontamination protocols.

6. The system of claim 5, wherein the guard applications are simultaneously and sequentially configured to at least one of: capture contaminants at their source, prevent lateral contamination spread, and actively deactivate and destroy pathogenic agents.

7. A contaminant mitigation system comprising one or more tiers, wherein each tier of the one or more tiers comprises at least one of: suction-based evacuation, air curtain formation, chemical mist dispersion, ultraviolet light sterilization, photocatalytic oxidation, targeted electromagnetic radiation, or molecular neutralization.

8. The system of claim 7, wherein the number of the one or more tiers is configurable.

9. The system of claim 7, wherein an order of the one or more tiers is configurable.

10. The system of claim 7, wherein a combination of the one or more tiers is configurable.
